(19) United States
(12) Patent Application Publication
(10) Pub. No.: US 2004/0227048 A1
(43) Pub. Date: Nov. 18, 2004

(54) Monitor frame

(76) Inventors: Timothy M. Lom, Alpharetta, GA (US); Lawrence S. Hamilton, Roswell, GA (US)

Correspondence Address: GEORGE R. REARDON, 3356 STATION COURT, LAWRENCVILLE, GA, 30044, US

(21) Appl. No.: 10/782,235

(22) Filed: Feb. 19, 2004

Related U.S. Application Data
(60) Provisional application No. 60/448,579, filed on Feb. 21, 2003.
(60) Provisional application No. 60/519,051, filed on Nov. 10, 2003.

(51) Int. Cl. B41J 11/02

(52) U.S. Cl. 248/442.2; 248/918

(57) ABSTRACT

A monitor frame for computer monitors that contains recessed pockets for inserting items, such as pictures, securing means, such as friction rings, to secure the inserted items, adapted for coupling to a computer monitor though attaching means to hingeably attach the monitor frame to a monitor. A method for installing and decorating the monitor frame. A method for building the monitor frame.

claim is hereby made for the benefit of U.S. Provisional Application No. 60/448,579 filed Feb. 21, 2003 and U.S. Provisional Application No. 60/519,051 filed Nov. 11, 2003 incorporated herein by reference.

### BACKGROUND OF THE INVENTION

This invention relates to a frame for an LCD or CRT type of monitor that facilitates a user personalizing said monitor with photos, color, graphics, logos, and the like. This is accomplished by using a mask device that will work with all similar sized monitors, easy to install or remove, and easy to change out front-loaded images/items that are inserted in the frame. The device is comprised of a four-sided frame that is removably attached on the user-facing front of a PC monitor, attaching means for securing and removing the frame; said frame is comprised of a plurality of recessed pockets, spaced at intervals around said frame; said pockets being suitably designed and enabled to receive decorative and other objects, and securing means for said decorative and other objects.

The human need to personalize surroundings to suit individual tastes and preferences is well known. As the line between work, home and recreation continues to blur, this need is extending to personalization of one's computer working space to assert one's individuality and to stay connected with emotionally important entities, such as: family, significant others, pets, sports figures, entertainers, motivation sources, travel destinations, etc. Additionally, the color of computer monitors does not always compliment the surroundings.

A typical computer arrangement generally has a standalone monitor, as well as other devices, such as a keyboard, mouse, etc. This arrangement can take up a considerable amount of desktop space. When separate picture frames and other items are also deployed in the immediate vicinity it can substantially reduce available working space. Additionally, available corporate individual working space has been decreasing as multiple workers are being placed in the same cubical or at the same table, called “hoteling”. Likewise, in the home office, space is also at a premium.

The market has produced many after-market or add-on accessories for various computer components, which are designed to save space, increase visual appearance, or increase office efficiency. Of these components, the monitor has spawned the most add-on accessories due to its close proximity to the worker, namely directly within the worker's reach and line of sight.

An example of such an add-on accessory is seen in U.S. Pat. No. 5,988,582, issued to Olivo, which discloses a device for organizing office paraphernalia that uses a PC monitor as a mounting surface. The device is comprised of a shroud mountable to a PC monitor groove, this groove being located behind the faceplate of most PC monitors. The shroud is comprised of two adjustable shroud members coupled together by a spring tensioner. The shroud members have an inner edge, an outer edge, and a front face disposed between the inner and outer edges. A plurality of projections disposed upon the inner edge of the shroud members engage within the PC monitor groove, when the shroud is placed upon a PC monitor. Once in place, the shroud surrounds three sides of the PC monitor and remains tensioned against the monitor, in the proper upright position, through the combined action of the projections disposed within the monitor groove and the spring tensioner holding the shroud members tightly against the monitor. A plurality of accessories may be mounted on the outer edges of the shroud members for holding office paraphernalia such as documents, business cards, pens, mirrors, and diskettes, to name a few. Additionally, the front face serves as a surface for placing “post-it” notes, or other stick-on paraphernalia.

Other known prior art includes U.S. Pat. No. 6,412,744, issued to Wollam, U.S. Pat. No. 6,543,167, issued to Dwyer, U.S. Pat. No. 6,478,282, issued to Flemming, U.S. Pat. No. 5,638,096, issued to Schwartz, U.S. Pat. No. 5,104,087, issued to Wentzloff, U.S. Pat. No. 4,869,565, issued to Bachman, U.S. Pat. No. 6,686,900, issued to Levy, and U.S. Pat. No. 6,443,415, issued to Sundblad.

While these and other previous devices have made an effort toward saving space by providing a means for mounting documents upon a computer monitor, these devices have virtually ignored allowing true personalization of the monitor. Specifically, these devices have been focused on office efficiency and allowing a worker to maintain a professional office appearance, instead of addressing the additional need for computer users to stay connected with their important emotional sources. Additionally, some of these devices employ elaborate, non-user friendly attaching means, such as clamps and springs, to secure these devices to the monitor.

Therefore, a need exists for a device and a system which utilize a computer monitor as a mounting surface, which employs simple attaching means, and which allows for a plurality of personal items to be inserted interchangeably therein and secured from. Additionally, the need exists for a three-dimensional colored frame over the outer face of the monitor to give it a distinctive look that harmonizes with its surroundings, as well as to give a way to personalize said frame.

The foregoing patent and other information reflect the state of the art of which the inventors are aware and are tendered with a view toward discharging the inventors' acknowledged duty of candor in disclosing information that may be pertinent to the patentability of the present invention. It is respectfully stipulated, however, that the foregoing patent and other information does not teach or render obvious, singly or when considered in combination, the inventors' claimed invention.

### BRIEF SUMMARY OF THE INVENTION

The general purpose of the present invention, which will be described subsequently in greater detail, is to provide a new computer monitor assembly apparatus and method which has many of the advantages of the computer monitor assemblies mentioned heretofore and many novel features that result in a new computer monitor assembly which is not anticipated, rendered obvious, suggested, or even implied by any of the prior art computer monitor assemblies, either alone or in any combination thereof.

One objective of the present invention is to provide a decorative attachment for a computer monitor that can be customized by the user through insertion of pictures that provide an emotional connection with past events or people.

Another objective of the present invention is to provide a decorative attachment for a computer monitor that can be customized with various themes, such as specific sports, sports players, sports entities, entertainment individuals, educational institutions, and the like, as well as having the capacity to be customized through insertion of items in the pockets.

Another objective of the present invention is to provide a customizable base for handicraft participants to use to apply current and future handicraft aspects.

A preferred embodiment of the present invention is comprised of the monitor frame with molded pockets placed at intervals around the front facing side of the monitor frame is attached to a computer monitor using complimentary hook-and-loop devices; wherein pictures or other decorative or useful items are inserted into the molded pockets; wherein the items may be covered with a protective transparent film or template; wherein the contents of the pockets may be held in place by friction rings that are inserted into the pockets after the contents have been inserted.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Further objects and advantages of the present invention will be apparent from the following detailed description of a presently preferred embodiment which is illustrated schematically in the accompanying drawings.

### BRIEF DESCRIPTION OF THE SEVERAL VIEWS OF THE DRAWING

Other advantages and features of the invention are described with reference to exemplary embodiments, which are intended to explain and not to limit the invention, and are illustrated in the drawings in which:

FIG. 1 is a front view of the invention without friction rings or images.

FIG. 2 is a back view of the invention from a diagonal perspective.

FIG. 3 is a front view of a monitor, showing the placement of the attaching means, using Velcro®, which attaches to the monitor.

FIG. 4 is a left side view of the invention.

FIG. 5 is a front view of the invention without friction rings or images, from a diagonal perspective.

FIG. 6 is a back view of the invention, mounted to a monitor, from a diagonal side perspective.

FIG. 7 is a back view of the invention from a bottom diagonal perspective.

FIG. 8 show the invention mounted to a monitor, with pictures inserted.

FIG. 9 shows the front of the invention mounted to a monitor, with pictures inserted and secured with friction-rings, from a diagonal perspective.

FIG. 10A, is a front view of the invention, showing friction rings without pictures inserted and referring to FIG. 10F.

FIG. 10B is a left side view of the invention.

FIG. 10C is a right side view of the invention.

FIG. 10D is a top view of the invention.

FIG. 10E is a bottom view of the invention.

FIG. 10F is a side view of the invention mounted on a monitor showing the relationship among the monitor, the monitor frame, the friction right, the image pockets, the image and the Velcro®.

FIG. 11 is a close-up view of the one portion of the invention that is shown in FIG. 10F.

FIG. 12 is a side view section of the invention showing a fuller view of the monitor.

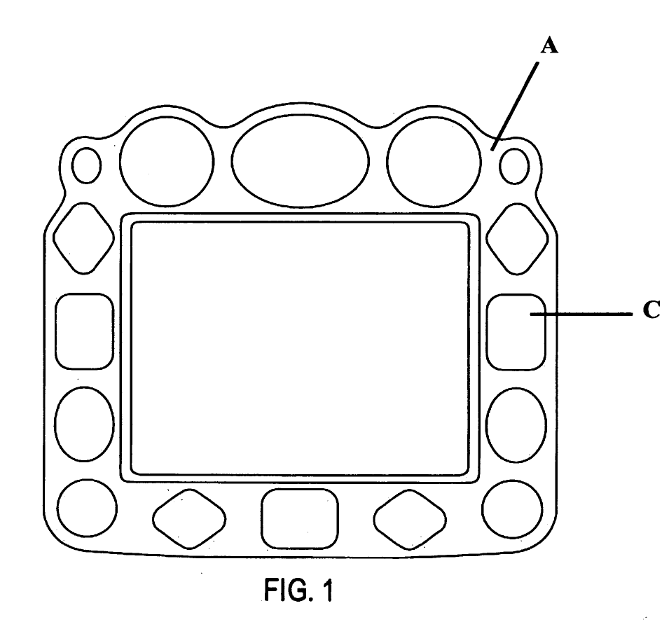

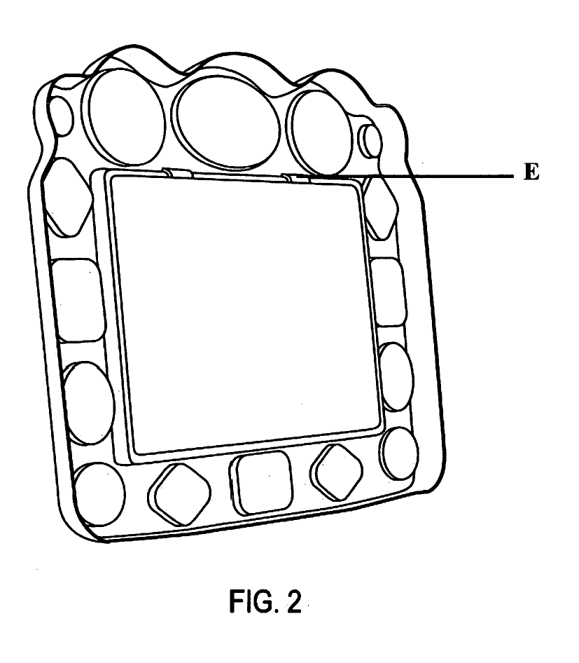

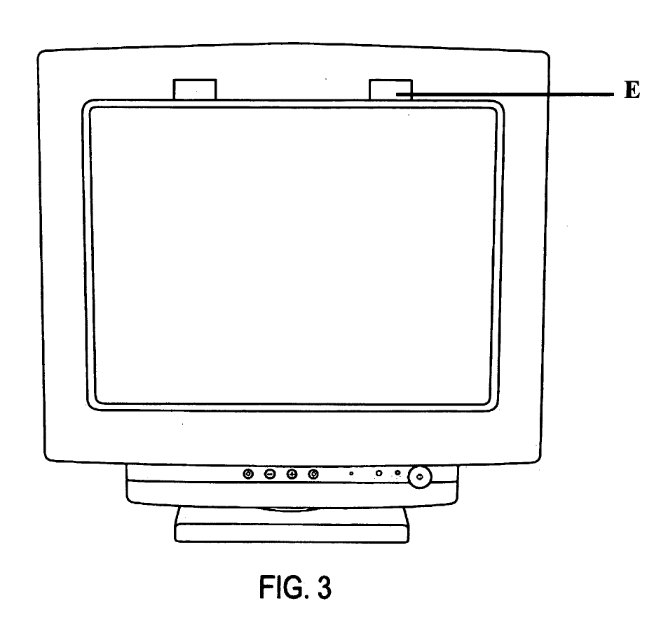

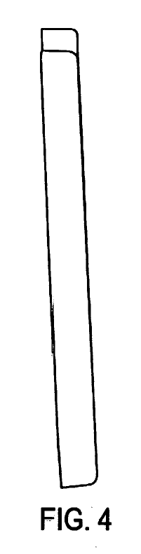

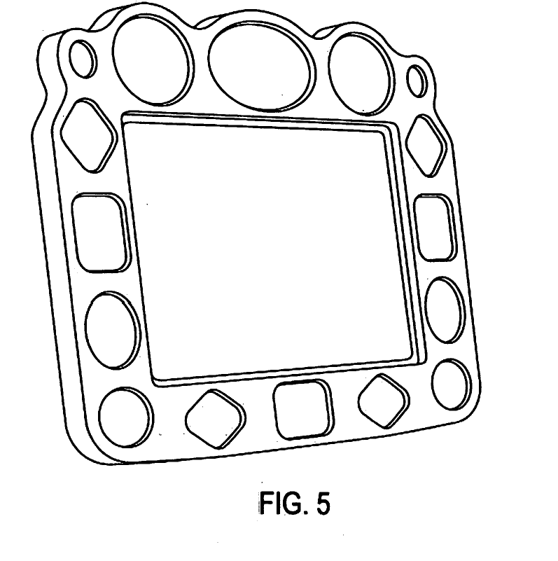

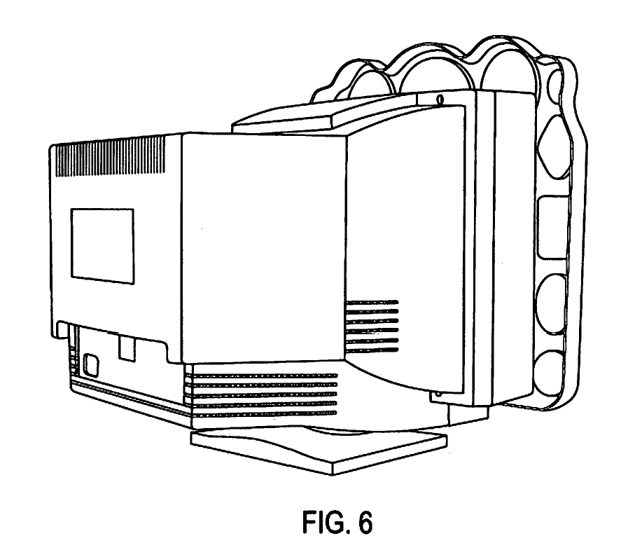

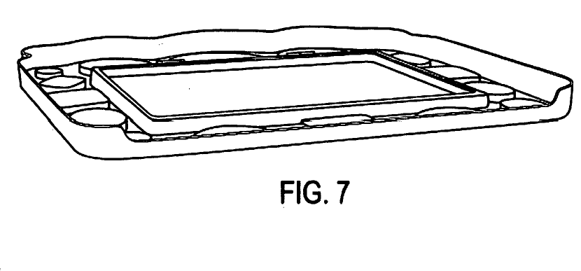

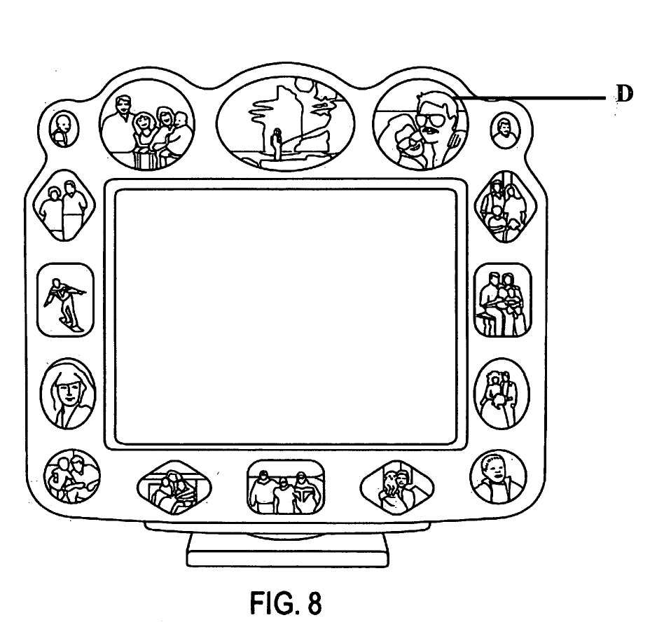

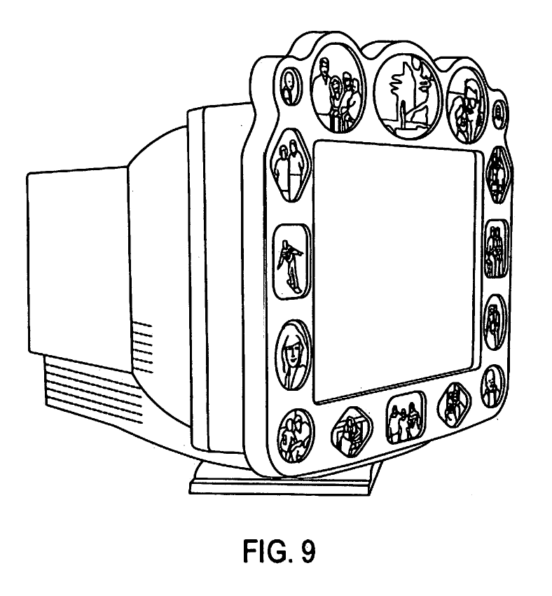

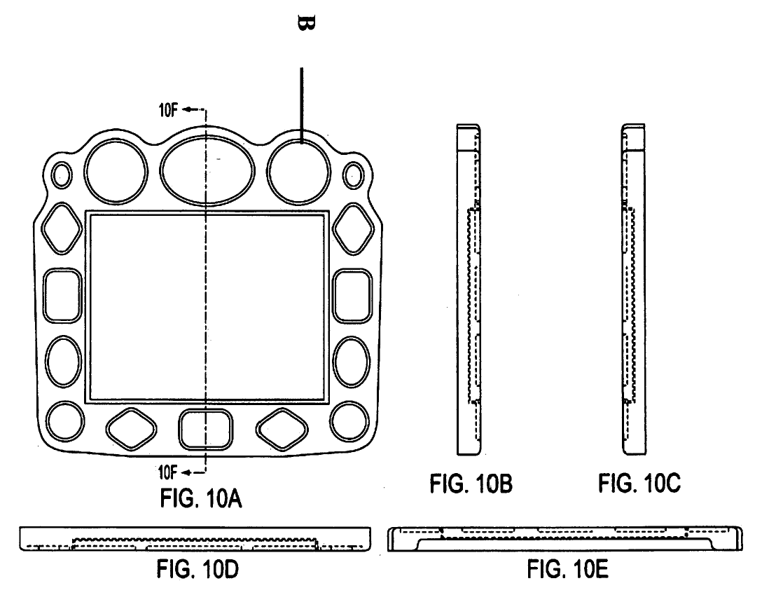

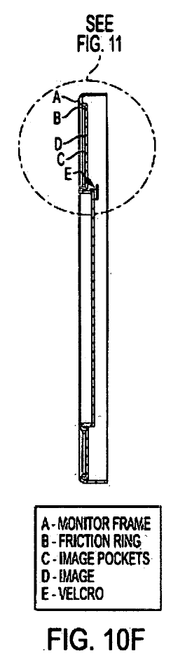

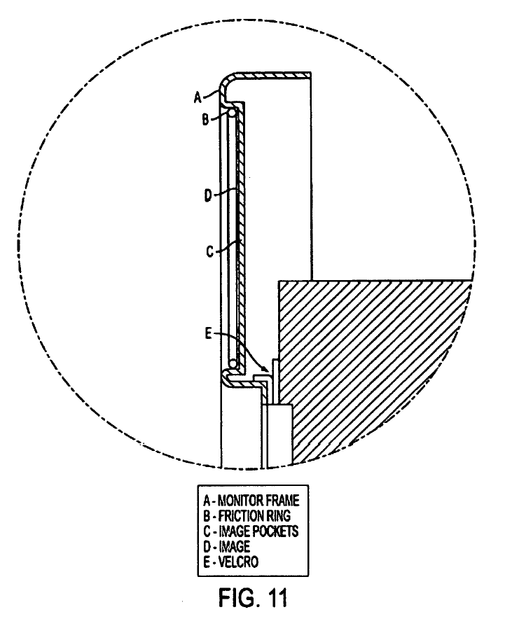

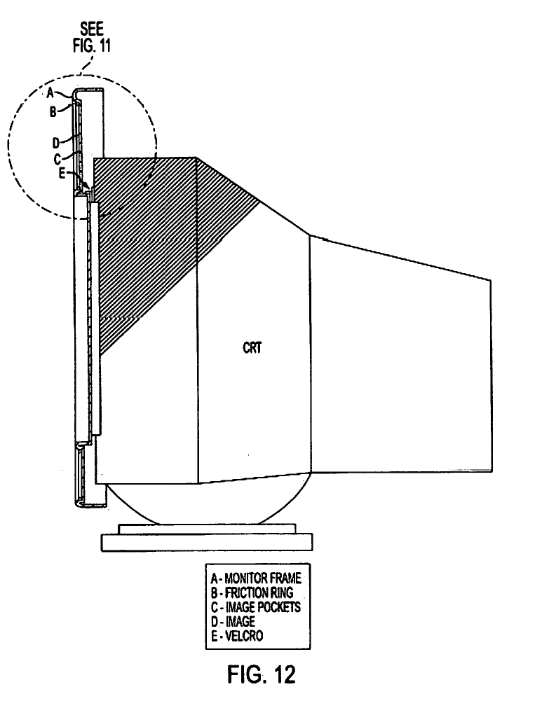

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

One embodiment of the present invention is comprised on the monitor frame, A, said monitor frame having a plurality of recessed pockets, C. Decorative items, D, are inserted into the pockets, C, after being prepared to fit. Friction ring securing means, B, are inserted into the pockets to hold the decorative items, D, in place. A first portion of hook and loop fastener attaching means, E, is coupled to the computer monitor for holding the monitor frame in a static position relative to the computer monitor. A complimentary portion of hook and loop fastener, E, is coupled to the back side of the monitor frame for engaging the first portion of hook and loop fastener attaching means. The monitor frame, A, is positioned on the computer monitor, F, such that the hook and loop fasteners engage and hold the assembly in a static position relative to the computer monitor, while allowing a pivoting motion.

The drawings show aspects of the invention. Pictures, logos, and other items can be placed in the various shaped pockets. While the following description will discuss the use of pictures to insert into the pockets, the use of this invention is not limited to pictures, since it is envisioned that a plurality of various inserts will be used.

Clear pocket-specific templates are provided with the frame to serve as a guide for tracing the pictures that the user would want to insert. These templates may also be used as a protective film over the decorative items, D. These templates may be die cut and held in matrix by nicking the die's blade. The user cuts the image to match the pocket shape and size using the appropriate template. The user then places the cut image in the corresponding pockets. The user then places a friction ring that is of the appropriate size for the corresponding pocket into the pocket to secure the inserted image. The friction ring uses expanding pressure of the ring along with the friction of the frame to the ring to secure the inserted picture. The pockets are precisely formed to the right dimension to match the corresponding dimension of the corresponding friction ring to securely hold the image in the frame.

The friction ring being used can be, but is not limited to, a nitrile O-ring. The friction ring material can be, but is not limited to, rubber, polyurethane, plastics, etc. These or other materials can be used for the friction rings, as long as the material used provides sufficient expanding pressure and/or material friction to hold the displayed picture in the pocket. This unique application will support other products as well.

The invention is thermal formed into or out of a plastic, or other suitable, material. The surface appearance of the plastic can be a uniform solid color, elaborate graphic designs, sports-related themes, entertainment-related themes, demographic-related themes, pyschographic-related themes, craft-related themes, etc., such as those shown in the drawings.

The attached drawings are proportioned for a 15-inch or 17-inch monitor. Although only one embodiment of this invention is illustrated and dimensioned, all or some of the relative dimensions, shape of the frame, the shape of the pockets, and location and size of the pockets can be modified to create different looks, and to fit different computer monitors. The scope of this invention includes all such modifications. The invention will be customized to accommodate other versions of various sized monitors.

The invention can be attached to the monitor using at least two sets of Velcro® tabs, or other suitable attaching means. These tabs are preferably placed on the backside of the invention, along the upper edge of the opening. This allows the invention to easily pivot upward and outward to allow the user to access any controls on the monitor.

This distinctive method of front-loading pictures, logos and other items that can be secured into the recessed pockets, along with the unique securing system is not limited to monitor frames, but also applies to other products such as multi-pocket photo frames that are hung on a wall, standalone devices, etc.

The user attaches the monitor frame to a monitor as follows:

1. Unplug the monitor from both the computer and the power.

2. Clean the face of the monitor where the monitor frame attaches. Clean monitor as per manufacturer recommendations. Note: if a residue remains after proper cleaning, wipe the areas where the adhesive will touch the monitor with a paper towel slightly dampened with Isopropyl (rubbing alcohol).

3. Locate the placement of the Velcro® tabs to the back of the monitor frame. First determine the curve of the face of the monitor by placing a straight edge object across the face of the monitor just above the screen. This information will decide whether option “a” or option “b” should be used.

a. Option a: If the straight edge can be rocked more than ⅛″ to both sides of the center of the monitor, placement of the Velcro® tabs is approximately 3″ in from the edge of the upper lip of the screen opening on the monitor frame.

b. Option b: If the straight edge rocks less than ⅛″ to both sides of the center, placement of the Velcro® tabs is just inside the opening on the upper lip of the monitor frame.

4. Turn the monitor frame over so the back is facing you, peel the liner off of one side of the mated Velcro® tabs and place the Velcro® tabs along the top lip of the screen opening, keeping the Velcro® flush to the edge of the opening (so as to not be visible from the front) and align the Velcro® in the position decided in 3a or 3b above.

5. After placing the Velcro® on the back of the monitor frame, remove the remaining liner from the Velcro®, hold the monitor frame in both hands facing the monitor just off the face of the monitor. Center the monitor frame's screen opening to the monitor's screen and press. If placement of the monitor frame is slightly misaligned, quickly pull off the Velcro® and re-adhere. The adhesive bond is not very strong in the first minute or two of adhering.

6. Press firmly on the frame where the Velcro® is located to ensure a secure bond.

The user assembles the photos into the monitor frame as follows:

1. Carefully detach the protection film/template from its sheet with scissors. Be extra careful not to scratch or dent the protective film/template while detaching or handling.

2. Align the protective film/template over the photo or image that has been selected for insertion into the monitor frame. Carefully trace around the protective film/template with an appropriate marking instrument.

3. Cut out the image with the scissors and place into the appropriate pocket on the monitor frame. Note: make sure that the selected image is not binding in the pocket. The selected image must lay flat. If it is binding, trim off the edges that are keeping it from laying flat.

4. Cover the image with the appropriate shaped protective film/template (if desired) and then insert the correct size friction ring into the pocket to hold it all into place. Note: the photo protection film/template's use is optional, as determined by the user's preference.

The user maintains the monitor frame as follows:

1. Just a periodic light dusting is all that is needed to keep up the attractive appearance of the monitor frame.

2. In case of soiling,

a. Remove the frame and disassemble the friction rings and images from the frame, along with any protective films/templates.

b. Carefully wipe the frame with warm water without the use of abrasive cloths or detergents.

c. Allow to completely dry

d. Reassemble.

One method of manufacturing the monitor frame is as follows:

1. Modified styrene is extruded to produce a flat blank the size needed for the product.

2. The flat modified styrene is then printed with etched cylinders, one cylinder per color. This process is called Gravure/Rotogravure. The printing process could also be done by high-end silk screening.

3. The ink is then covered with polystyrene film (gloss, satin or matt sheen). This film serves mainly as protection to the printed image on the monitor frame.

4. The printed film covered flat blank is then vacuum formed onto a male or into a female mold, depending on what is required. To hold tolerances for the friction rings on the monitor frame, a female mold is required.

5. The vacuum formed part's excess flanges are then roll trimmed for the final shape.

Another possible manufacturing process includes injection molding, using in-mold decorating for the graphics. If graphics are not needed, injection molding can be the most cost effective if the quantities to be produced are high enough. Other suitable manufacturing processes known in the art can also be utilized.

We claim:

1. A multi-purpose computer monitor frame for removably mounting onto a computer monitor thereon, which comprises:
a plurality of corners and a plurality of sides, said sides and corners defining an opening through which the screen of said computer monitor is viewable,
a plurality of recessed areas disposed in said computer monitor frame,
means for protecting items inserted into said recessed areas,
means for securing said items in said recessed areas, and
a first mounting means for removably mounting said computer monitor frame on said computer monitor.

2. The multi-purpose computer monitor frame as defined in claim 1, which further comprises:
a second mounting means for removably mounting the computer monitor frame on the monitor, the second mounting means being disposed in a plurality of places on the rear side of the computer monitor frame and in a plurality of corresponding places on the computer monitor,
the second mounting means allowing the computer monitor frame of being hingable with respect to the top side of the frame about an axis of rotation which is perpendicular to the top edge of the computer monitor frame.

3. The multi-purpose computer monitor frame as defined in claim 2, wherein the second mounting means is a hook and loop closure with adhesive backing.

4. The multi-purpose computer monitor frame as defined in claim 3, which further comprises:
a plurality of transparent films operable for placing over said inserts.

5. The multi-purpose computer monitor frame as defined in claim 4, which further comprises:
a plurality of templates operable for placing over said inserts, such that the templates create a frame around said inserts.

6. The multi-purpose computer monitor frame as defined in claim 3, which further comprises:
a plurality of templates operable for placing over said inserts.

7. The multi-purpose computer monitor frame as defined in claim 5, wherein the securing means are friction rings.

8. The multi-purpose computer monitor frame as defined in claim 6, wherein the securing means are friction rings.

9. The multi-purpose computer monitor frame as defined in claim 3, wherein the securing means are friction rings.

10. The multi-purpose computer monitor frame as defined in claim 3, wherein the friction rings are nitrile O-rings.

11. A method for installing the computer monitor frame comprising the steps of:
a. Unplugging the monitor from both the computer and the power,
b. Cleaning the face of the monitor where the monitor frame attaches as per manufacturer recommendations,
c. Locating the placement of the Velcro® tabs to the back of the monitor frame by:
i. Determining the curve of the face of the monitor by placing a straight edge object across the face of the monitor just above the screen,
ii. Selecting Option a if the straight edge can be rocked more than ⅛″ to both sides of the center of the monitor and placing the Velcro® tabs approximately 3″ in from the edge of the upper lip of the screen opening on the monitor frame, or
iii. Selection Option b if the straight edge rocks less than ⅛″ to both sides of the center and placing the Velcro® tabs just inside the opening on the upper lip of the monitor frame,
d. Turning the monitor frame over so the back is facing the installer,
e. Peeling the liner off of one side of the mated Velcro® tabs,
f. Placing the Velcro® tabs along the top lip of the screen opening, keeping the Velcro® flush to the edge of the opening (so as to not be visible from the front) and align the Velcro® in the position decided in Option a or Option b above,
g. Removing the remaining liner from the Velcro®,
h. Holding the monitor frame in both hands facing the monitor just off the face of the monitor,
i. Centering the monitor frame's screen opening to the monitor's screen and pressing, and
j. Pressing firmly on the frame where the Velcro® is located to ensure unplugging the computer monitor.

12. A method for building the monitor frame comprising the steps of:
a. extruding modified styrene to produce a flat blank the size needed for the product,
b. printing the flat modified styrene with etched cylinders, one cylinder per color,
c. covering the ink with polystyrene film with a gloss, satin or matt sheen, to protect the printed image on the monitor frame,
d. vacuum-forming the printed film covered flat blank is then vacuum onto a male mold; and,
e. roll trimming the vacuum formed part's excess flanges for the final shape.
